(19) United States
(12) Patent Application Publication
(10) Pub. No.: US 2005/0104254 A1
(43) Pub. Date: May 19, 2005

(54) Process for producing lumber type product from carpet

(76) Inventor: David Hall, Savoy, TX (US)

Correspondence Address: W. Thomas Timmons;The White House on Turtle Creek, 2401 Turtle Creek Blvd., Dallas, TX, 75219-4760, US

(21) Appl. No.: 10/716,643

(22) Filed: Nov. 19, 2003

(51) Int. Cl. B29C 43/00

(52) U.S. Cl. 264/324; 264/325

(57) ABSTRACT

A process for producing a lumber type product from scrap carpet, includes the steps of shredding the scrap carpet, grinding the shredded carpet in a plurality of grinding stages, and heating the grinded carpet in a plurality of heating stages. Each succeeding heating stage heats the grinded carpet to a higher predetermined temperature range. In a preferred process, the plurality of grinding stages comprises a first grinding stage and a second grinding stage and the plurality of heating stages comprises at least three heating stages, preferably five. In a process according, in a preferred arrangement, grinding the shredded carpet includes grinding the shredded carpet to pass through a one half inch screen and grinding the carpet a second time to pass through a screen of from about one fourth inch to about three eighths inch. In a preferred process according to the present invention, the first predetermined temperature range is from about 205 to about 255 degrees Fahrenheit, the second predetermined temperature range is from about 275 to about 310 degrees Fahrenheit, the third temperature range is from about 340 to about 385 degrees Fahrenheit, the fourth predetermined temperature range is from about 395 to about 435 degrees Fahrenheit, and the fifth predetermined temperature range is from about 430 to about 465 degrees Fahrenheit. In a preferred range of temperatures, the first predetermined temperature range is from about 225 to about 245 degrees Fahrenheit, the second predetermined temperature range is from about 285 to about 305 degrees Fahrenheit, the third temperature range is from about 360 to about 380 degrees Fahrenheit, the fourth predetermined temperature range is from about 405 to about 425 degrees Fahrenheit, and the fifth predetermined temperature range is from about 435 to about 455 degrees Fahrenheit. After the carpet has been substantially melted from heating, further steps include extruding the melted carpet into a mold and cooling the mold and the extruded melted carpet. Cooling the mold and the extruded melted carpet includes placing the mold into water and circulating the water.

### BACKGROUND OF THE INVENTION

1. Field of the Invention

The present invention relates generally to a process for making a lumber type product from scrap carpet.

2. Description of Related Art

Carpet scraps have been recycled into lumber type products, but normally, only part of the carpet is used and plastic is added.

### SUMMARY OF THE INVENTION

A process according to the present invention for producing a lumber type product from scrap carpet, includes shredding the scrap carpet, grinding the shredded carpet, heating the grinded carpet to a first predetermined temperature range, heating the grinded carpet to a second predetermined temperature range which is higher than the first predetermined temperature range, heating the grinded carpet to a third predetermined temperature range which is higher than the second predetermined temperature range, heating the grinded carpet to a fourth predetermined temperature range which is higher than the third predetermined temperature range, and heating the grinded carpet to a fifth predetermined temperature range which is higher than the fourth predetermined temperature range. In a process according, in a preferred arrangement, grinding the shredded carpet includes grinding the shredded carpet to pass through a one half inch screen and grinding the carpet a second time to pass through a screen of from about one fourth inch to about three eighths inch.

In a preferred process according to the present invention, the first predetermined temperature range is from about 205 to about 255 degrees Fahrenheit, the second predetermined temperature range is from about 275 to about 310 degrees Fahrenheit, the third temperature range is from about 340 to about 385 degrees Fahrenheit, the fourth predetermined temperature range is from about 395 to about 435 degrees Fahrenheit, and the fifth predetermined temperature range is from about 430 to about 465 degrees Fahrenheit.

In a preferred range of temperatures, the first predetermined temperature range is from about 225 to about 245 degrees Fahrenheit, the second predetermined temperature range is from about 285 to about 305 degrees Fahrenheit, the third temperature range is from about 360 to about 380 degrees Fahrenheit, the fourth predetermined temperature range is from about 405 to about 425 degrees Fahrenheit, and the fifth predetermined temperature range is from about 435 to about 455 degrees Fahrenheit. After the carpet has been substantially melted from heating, further steps include extruding the melted carpet into a mold and cooling the mold and the extruded melted carpet. Cooling the mold and the extruded melted carpet includes placing the mold into water and circulating the water.

More generally, a process according to the present invention for producing a lumber type product from scrap carpet, includes the steps of shredding the scrap carpet, grinding the shredded carpet in a plurality of grinding stages, and heating the grinded carpet in a plurality of heating stages. Each succeeding heating stage heats the grinded carpet to a higher predetermined temperature range. In a preferred process, the plurality of grinding stages comprises a first grinding stage and a second grinding stage and the plurality of heating stages comprises at least three heating stages, preferably five.

A product manufactured according to the process of this invention has many of the desirable qualities of treated wood, but lasts longer and, in many other ways, exceeds wood.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is a pictorial representation of a system according to the present invention for producing a lumber type product from scrap carpet;

FIG. 2 is a flow chart of a method according to the present invention for producing a lumber type product from scrap carpet;

FIG. 3 is a side elevational view of a mold according to the present invention;

FIG. 4 is a cross-sectional view of the mold of FIG. 3;

FIG. 5 is a side elevational view of an alternative mold according to the present invention;

FIG. 6 is a cross-sectional view of the mold of FIG. 5;

FIG. 7 is a side elevational view of an alternative mold according to the present invention;

FIG. 8 is a cross-sectional view of the mold of FIG. 7;

FIG. 9 is a cross-sectional view of a product according to the present invention, taken from the mold of FIG. 3;

FIG. 10 is a cross-sectional view of a product according to the present invention, taken from the mold of FIG. 5; and

FIG. 11 is a cross-sectional view of a product according to the present invention, taken from the mold of FIG. 7.

### DESCRIPTION OF THE PREFERRED EMBODIMENT

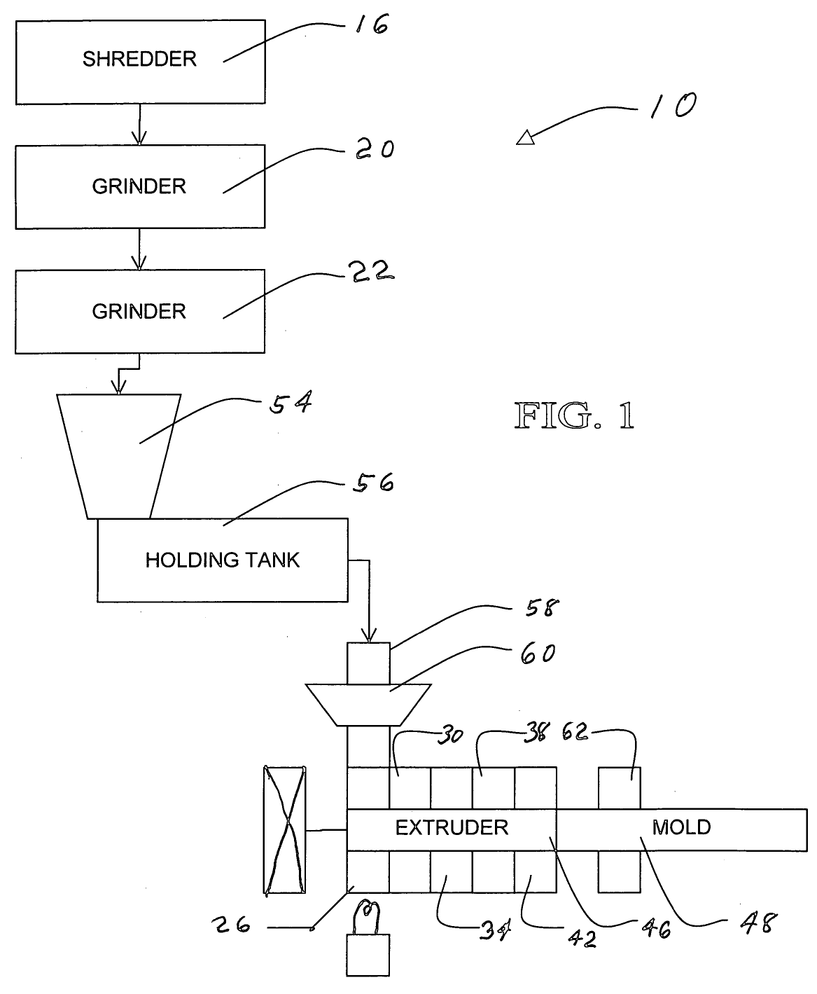

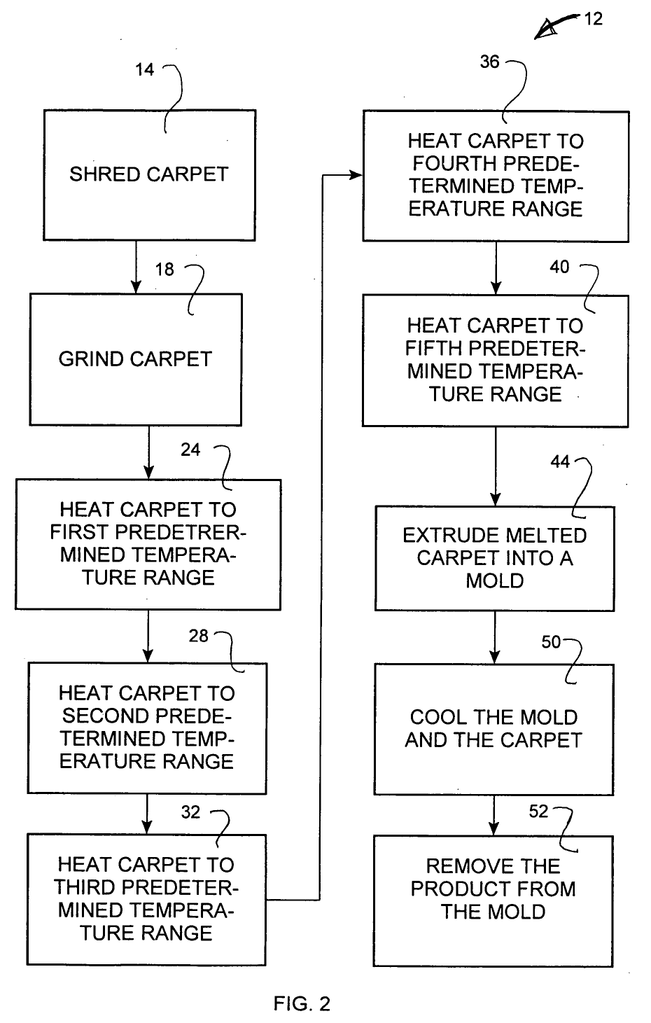

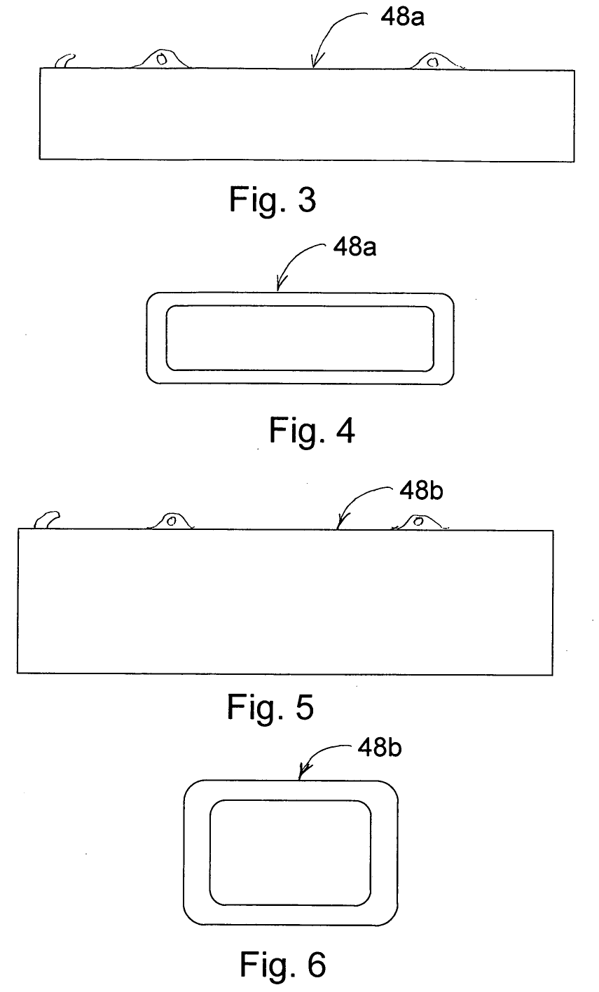

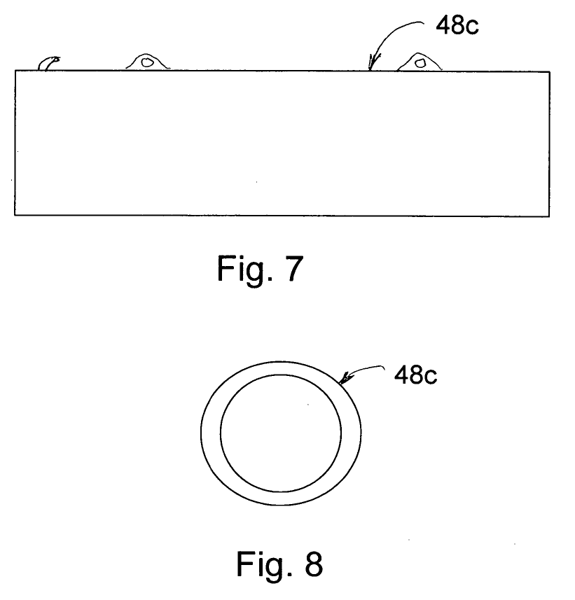

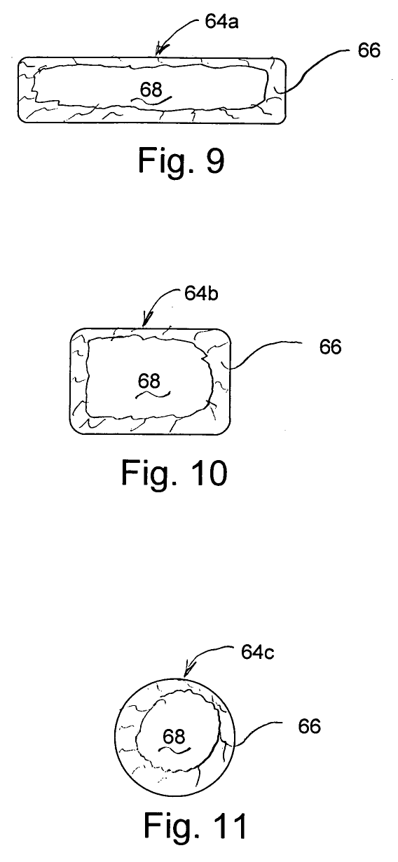

Referring now to the drawing, and in particular to FIG. 1 and FIG. 2, a system according to the present invention is referred to generally by reference numeral 10 and a process according to the present invention is referred to generally by reference numeral 12. Process 12 according to the present invention for producing a lumber type product from scrap carpet, includes shredding 14 the scrap carpet in grinder 16, grinding 18 the shredded carpet in grinders 20 and 22, heating 24 the grinded carpet to a first predetermined temperature range in a first heating area 26, heating 28 in a second heating area 30 the grinded carpet to a second predetermined temperature range which is higher than the first predetermined temperature range, heating 32 in a third heating area 34 the grinded carpet to a third predetermined temperature range which is higher than the second predetermined temperature range, heating 36 in a fourth heating area 38 the grinded carpet to a fourth predetermined temperature range which is higher than the third predetermined temperature range, and heating 40 in a fifth heating area 42 the grinded carpet to a fifth predetermined temperature range which is higher than the fourth predetermined temperature range. In a preferred arrangement of the process, grinding the shredded carpet includes grinding the shredded carpet to pass through a one half inch screen in first grinder 20 and grinding the carpet a second time to pass through a screen of from about one fourth inch to about three eighths inch in second grinder 22.

In a preferred process according to the present invention, the first predetermined temperature range is from about 205 to about 255 degrees Fahrenheit, the second predetermined temperature range is from about 275 to about 310 degrees Fahrenheit, the third temperature range is from about 340 to about 385 degrees Fahrenheit, the fourth predetermined temperature range is from about 395 to about 435 degrees Fahrenheit, and the fifth predetermined temperature range is from about 430 to about 465 degrees Fahrenheit.

In a preferred range of temperatures, the first predetermined temperature range is from about 225 to about 245 degrees Fahrenheit, the second predetermined temperature range is from about 285 to about 305 degrees Fahrenheit, the third temperature range is from about 360 to about 380 degrees Fahrenheit, the fourth predetermined temperature range is from about 405 to about 425 degrees Fahrenheit, and the fifth predetermined temperature range is from about 435 to about 455 degrees Fahrenheit. After the carpet has been substantially melted from heating, further steps include extruding 44 the melted carpet by means of an extruder 46 into a mold 48 and cooling 50 the mold and the extruded melted carpet. Cooling the mold and the extruded melted carpet includes placing the mold into water and circulating the water. The product is then removed 52 from the mold.

More generally, a process according to the present invention for producing a lumber type product from scrap carpet, includes the steps of shredding the scrap carpet, grinding the shredded carpet in a plurality of grinding stages, and heating the grinded carpet in a plurality of heating stages. Each succeeding heating stage heats the grinded carpet to a higher predetermined temperature range. In a preferred process, the plurality of grinding stages comprises a first grinding stage and a second grinding stage and the plurality of heating stages comprises at least three heating stages, preferably five.

A product manufactured according to the process of this invention has many of the desirable qualities of treated wood, but lasts longer and, in many other ways, exceeds wood.

Typical size of lumber or boards are from ½ inch thick to 8 inches thick and can be any size, such as 1 inch×4 inches×12 feet, 2 inches×6 inches×12 feet, 4 inches×4 inches×8 feet, 8 inches×8 inches×8 feet or like a sheet of wafer board mix into ½ in. thick sheets 4 feet×8 feet or as thick as 3 inches in 4 feet×10 feet pieces.
1. Bring in all plastic, nylon and tile carpet to be recycled from the waste string to be processed.
2. Bust the carpet bales and, then, check for any foreign matter in the carpet. Tile carpet is used, then the tile is separated from the carpet and recycled separately.
3. Put the carpet on a conveyer. All the plastic, nylon and tile carpet to be recycled is shredded together into smaller pieces.
4. The shredded carpet plastic, nylon and tiles will not go through and falls into grinder 20 that has ½ inch screens.
5. The grinded carpet plastic, nylon, tiles will not go through second grinder 22 that his a ¼ to ⅜ screens.
6. Through the second grinder, the carpet plastic, nylon, tiles is brought by a vacuum line 54 into a holding tank 56.
7. From holding tank, the carpet plastic, nylon, and tiles go to the process tank 58 on the top of extruder 46.
8. Then the carpet plastic, nylon, dies turn into a fluff, so a crammer 60 on top of the extruder feeds it.
9. The fluff is crammed down the throat of the extruder because the fluff will not fall. It has to be forced into the extruder.
10. The extruder has five heat zones to melt the carpet plastic, nylon and tiles into lumber. The preferred temperature shown for each zone but the temperature can go up or down 10 to 20 degrees.
11. Zone 1 temperature should be in the range from 205 to 255 degrees. The preferred temperature is around 235 degrees.
12. Zone 2 temperature should be from 275 to 310 degrees. Preferred temperature is around 295 degree.
13. Zone 3 temperature should be from 340 to 385 degrees. Preferred temperature is around 370 degrees.
14. Zone 4 temperature should be from 395 to 435 degrees. Preferred temperature is around 415 degrees.
15. Zone 5 temperature should be from 430 to 465 degrees. Preferred temperature is around 445 degrees.
16. After the carpet composite goes through the extruder, it goes through a die 62 that is attached onto the front the extruder.
17. The die will hold mold 48; the melted composite of carpet plastic, nylon, and tile flows down into the molds.
18. As the melted composite of carpet plastic, nylon, and tile flows down into the mold, the outside of the composite will start making a hard outer shell. The hot melted composite of carpet plastic, nylon, and tile will push the hard shell 66 to the outside in the molds.
19. After the melted composite carpet plastic, nylon, and tile fills the mold, slow the extruder and take the mold off the end of the die and throw into a tank of water so it can cool down. In a preferred arrangement, the water in the tank is circulated to cool the mold and workpiece more quickly.
20. After the carpet plastic, nylon, and tile mold cools for about 70 minutes, remove the lumber from the mold by taking a hammer and a rod and hitting on the open end of the mold, and the carpet lumber 64 will fall out of the mold. Inside of hard shell 66 is a core of softer, but still substantial material 68.
21. After the composite carpet plastic, nylon, and tile is out of the mold, pull the mold back in line to do the process of making lumber or boards.

The product 64 lasts as long as treated lumber or treated plywood. A major 2 0 advantage of the product is that all of the carpet is used, and different carpets can all be thrown together. It works just like treated lumber and treated plywood. A worker can cut it with a saw, nail it with a hammer, nail it with a nail gun, screw down with a drill or screw gun, or drill holes in it. The product will not rough, mildew or split.

The product will be good in decking, board walks, porches, outside furniture, fences, and trailers floors. The product is being tested for use in building barns and houses.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A process for producing a lumber type product from scrap carpet, comprising in combination:
shredding the scrap carpet;
grinding the shredded carpet;
heating the grinded carpet to a first predetermined temperature range;
heating the grinded carpet to a second predetermined temperature range which is higher than the first predetermined temperature range; and
heating the grinded carpet to a third predetermined temperature range which is higher than the second predetermined temperature range.

2. A process according to claim 1, further including:
heating the grinded carpet to a fourth predetermined temperature range which is higher than the third predetermined temperature range; and
heating the grinded carpet to a fifth predetermined temperature range which is higher than the fourth predetermined temperature range.

3. A process according to claim 2, wherein the first predetermined temperature range is from about 205 to about 255 degrees Fahrenheit, the second predetermined temperature range is from about 275 to about 310 degrees Fahrenheit, the third temperature range is from about 340 to about 385 degrees Fahrenheit, the fourth predetermined temperature range is from about 395 to about 435 degrees Fahrenheit, and the fifth predetermined temperature range is from about 430 to about 465 degrees Fahrenheit.

4. A process according to claim 3, wherein grinding the shredded carpet comprises grinding the shredded carpet to pass through a one half inch screen and grinding the carpet a second time to pass through a screen of from about one fourth inch to about three eighths inch.

5. A process according to claim 4, wherein the carpet has been substantially melted from heating, further including:
extruding the melted carpet into a mold; and
cooling the mold and the extruded melted carpet.

6. A process according to claim 5, wherein cooling the mold and the extruded melted carpet comprises placing the mold into water and circulating the water.

7. A product manufactured according to the process of claim 6.

8. A process according to claim 2, wherein the first predetermined temperature range is from about 225 to about 245 degrees Fahrenheit, the second predetermined temperature range is from about 285 to about 305 degrees Fahrenheit, the third temperature range is from about 360 to about 380 degrees Fahrenheit, the fourth predetermined temperature range is from about 405 to about 425 degrees Fahrenheit, and the fifth predetermined temperature range is from about 435 to about 455 degrees Fahrenheit.

9. A process according to claim 8, wherein grinding the shredded carpet comprises grinding the shredded carpet to pass through a one half inch screen and grinding the carpet a second time to pass through a screen of from about one fourth inch to about three eighths inch.

10. A process according to claim 9, wherein the carpet has been substantially melted from heating, further including:
extruding the melted carpet into a mold; and
cooling the mold and the extruded melted carpet.

11. A process according to claim 10, wherein cooling the mold and the extruded melted carpet comprises placing the mold into water and circulating the water.

12. A product manufactured according to the process of claim 11.

13. A process according to claim 1, wherein grinding the shredded carpet comprises grinding the shredded carpet to pass through a one half inch screen and grinding the carpet a second time to pass through a screen of from about one fourth inch to about three eighths inch.

14. A process according to claim 13, wherein the carpet has been substantially melted from heating, further including:
extruding the melted carpet into a mold; and
cooling the mold and the extruded melted carpet.

15. A process according to claim 14, wherein cooling the mold and the extruded melted carpet comprises placing the mold into water and circulating the water.

16. A product manufactured according to the process of claim 15.

17. A process for producing a lumber type product from scrap carpet, comprising in combination:
shredding the scrap carpet;
grinding the shredded carpet in a plurality of grinding stages;
heating the grinded carpet in a plurality of heating stages, wherein each succeeding heating stage heats the grinded carpet to a higher predetermined temperature range.

18. A process according to claim 17, wherein grinding the shredded carpet comprises grinding the shredded carpet to pass through a one half inch screen and grinding the carpet a second time to pass through a screen of from about one fourth inch to about three eighths inch.

19. A process according to claim 18, wherein the carpet has been substantially melted from heating, further including:
extruding the melted carpet into a mold; and
cooling the mold and the extruded melted carpet.

20. A process according to claim 19, wherein cooling the mold and the extruded melted carpet comprises placing the mold into water and circulating the water.

21. A process according to claim 20 wherein the plurality of grinding stages comprises a first grinding stage and a second grinding stage and wherein the plurality of heating stages comprises at least three heating stages.

22. A process according to claim 21 wherein the plurality of grinding stages comprises a first grinding stage and a second grinding stage and wherein the plurality of heating stages comprises at least three heating stages.

23. A product manufactured according to the process of claim 22.
